(19) United States
(12) Patent Application Publication
(10) Pub. No.: US 2026/0247102 A1
(43) Pub. Date: Aug. 20, 2026

(54) CARRIER AGGREGATION BASED DOWNLINK POSITIONING FOR OUTSIDE OF A MEASUREMENT GAP

(71) Applicant: NOKIA TECHNOLOGIES OY, Espoo (FI)

(72) Inventors: Hyun-Su CHA, Chicago, IL (US); Ryan KEATING, Chicago, IL (US); Gilsoo LEE, Naperville, IL (US)

(21) Appl. No.: 19/156,806

(22) PCT Filed: Nov. 24, 2023
(86) PCT No.: PCT/EP2023/082948

§ 371 Date: Aug. 14, 2025

Related U.S. Application Data
(60) Provisional application No. 63/445,945, filed on Feb. 15, 2023.

(51) Int. Cl. H04W 4/02; H04W 24/10; H04W 36/00

(52) U.S. Cl. CPC H04W 4/025; H04W 24/10; H04W 36/00692

(57) ABSTRACT

Carrier aggregation-based downlink positioning for outside of a measurement gap is provided. A method for carrier aggregation-based downlink positioning may include receiving, from a location management function, a request to report positioning measurement reporting by carrier aggregation across a plurality of positioning frequency layers. The method may also include transmitting, to the location management function according to provided rules, a positioning measurement report indicating at least one of the plurality of positioning frequency layers that the apparatus successfully measures or failed to measure.

### TECHNICAL FIELD

Some example embodiments may generally relate to mobile or wireless telecommunication systems, such as Long Term Evolution (LTE) or fifth generation (5G) new radio (NR) access technology, or 5G beyond, or other communications systems. For example, certain example embodiments may relate to carrier aggregation-based downlink (DL) positioning for outside of a measurement gap.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) wireless systems refer to the next generation (NG) of radio systems and network architecture. 5G network technology is mostly based on new radio (NR) technology, but the 5G (or NG) network can also build on E-UTRAN radio. It is estimated that NR may provide bitrates on the order of 10-20 Gbit/s or higher, and may support at least enhanced mobile broadband (eMBB) and ultra-reliable low-latency communication (URLLC) as well as massive machine-type communication (mMTC). NR is expected to deliver extreme broadband and ultra-robust, low-latency connectivity and massive networking to support the Internet of Things (IoT).

### SUMMARY

Various exemplary embodiments may provide an apparatus including at least one processor and at least one memory storing instructions. The stored instructions, when executed by the at least one processor, cause the apparatus at least to receive, from a location management function, a request to report positioning measurement reporting by carrier aggregation across a plurality of positioning frequency layers (PFLs). The apparatus may also be caused to transmit, to the location management function according to provided rules, a positioning measurement report indicating at least one of the plurality of positioning frequency layers (PFLs) that the apparatus successfully measures or failed to measure.

Some exemplary embodiments may provide an apparatus including at least one processor and at least one memory storing instructions. The stored instructions, when executed by the at least one processor, cause the apparatus at least to transmit, to a user equipment, configurations including rules to configure the user equipment to drop receiving positioning reference signals (PRS) resources when the user equipment fails to obtain a positioning measurement report by carrier aggregation (CA) within positioning processing windows (PPW) across a plurality of positioning frequency layers (PFLs). The apparatus may be further caused to reconfigure and transmit, to the user equipment, one or more positioning processing windows (PPWs) for one or more of the plurality of positioning frequency layers (PFLs) that the user equipment previously failed to measure.

Various exemplary embodiments may provide an apparatus including at least one processor and at least one memory storing instructions. The stored instructions, when executed by the at least one processor, cause the apparatus at least to provide, to a user equipment, a request and rules to report positioning measurement reporting by carrier aggregation (CA) across a plurality of positioning frequency layers (PFLs). The apparatus may also be caused to receive, from the user equipment according to the provided rules, a positioning measurement report indicating at least one or more of the plurality of positioning frequency layers (PFLs) that the user equipment successfully measures or failed to measure.

Certain exemplary embodiments may provide an apparatus including means for receiving, from a location management function, a request to report positioning measurement reporting by carrier aggregation across a plurality of positioning frequency layers (PFLs), and means for transmitting, to the location management function according to provided rules, a positioning measurement report indicating at least one of the plurality of positioning frequency layers (PFLs) that the apparatus successfully measures or failed to measure.

Various exemplary embodiments may provide an apparatus including means for transmitting, to a user equipment, configurations including rules to configure the user equipment to drop receiving positioning reference signals (PRS) resources when the user equipment fails to obtain a positioning measurement report by carrier aggregation (CA) within positioning processing windows (PPW) across a plurality of positioning frequency layers (PFLs). The apparatus may also include means for reconfiguring and transmitting, to the user equipment, one or more positioning processing windows (PPWs) for one or more of the plurality of positioning frequency layers (PFLs) that the user equipment previously failed to measure.

Certain exemplary embodiments may provide an apparatus including means for providing, to a user equipment, a request and rules to report positioning measurement reporting by carrier aggregation (CA) across a plurality of positioning frequency layers (PFLs), and means for receiving, from the user equipment according to the provided rules, a positioning measurement report indicating at least one or more of the plurality of positioning frequency layers (PFLs) that the user equipment successfully measures or failed to measure.

Some exemplary embodiments may provide a method including receiving, from a location management function, a request to report positioning measurement reporting by carrier aggregation across a plurality of positioning frequency layers (PFLs). The method may also include transmitting, to the location management function according to provided rules, a positioning measurement report indicating at least one of the plurality of positioning frequency layers (PFLs) that an apparatus successfully measures or failed to measure.

Certain exemplary embodiments may provide a method including transmitting, to a user equipment, configurations including rules to configure the user equipment to drop receiving positioning reference signals (PRS) resources when the user equipment fails to obtain a positioning measurement report by carrier aggregation (CA) within positioning processing windows (PPW) across a plurality of positioning frequency layers (PFLs). The method may also include reconfiguring and transmitting, to the user equipment, one or more positioning processing windows (PPWs) for one or more of the plurality of positioning frequency layers (PFLs) that the user equipment previously failed to measure.

Various exemplary embodiments may provide a method including providing, to a user equipment, a request and rules to report positioning measurement reporting by carrier aggregation (CA) across a plurality of positioning frequency layers (PFLs). The method may also include receiving, from the user equipment according to the provided rules, a positioning measurement report indicating at least one or more of the plurality of positioning frequency layers (PFLs) that the user equipment successfully measures or failed to measure.

Various exemplary embodiments may provide a non-transitory computer readable storage medium storing instruction that, when executed by at least one processor of an apparatus, causes the apparatus at least to perform one or more methods described herein. Some exemplary embodiments may provide a computer program including instructions that, when executed by an apparatus, cause the apparatus to perform one or more methods described herein. Certain exemplary embodiments may provide an apparatus including one or more circuitry configured to perform one or more methods described herein.

### BRIEF DESCRIPTION OF THE DRAWINGS

For proper understanding of example embodiments, reference should be made to the accompanying drawings, as follows:

FIG. 1 illustrates an example of carrier aggregation (CA) based positioning attempted outside of a measurement gap;

FIG. 2 illustrates an exemplary signal diagram for CA-based positioning, according to some exemplary embodiments;

FIG. 3 illustrates an example of a flow diagram of a method, according to various exemplary embodiments;

FIG. 4 illustrates an example of a flow diagram of another method, according to various exemplary embodiments;

FIG. 5 illustrates an example of a flow diagram of a further method, according to certain exemplary embodiments; and

FIG. 6 illustrates a set of apparatuses, according to various exemplary embodiments.

### DETAILED DESCRIPTION

It will be readily understood that the components of certain example embodiments, as generally described and illustrated in the figures herein, may be arranged and designed in a wide variety of different configurations. The following is a detailed description of some exemplary embodiments of systems, methods, apparatuses, and non-transitory computer program products for carrier aggregation-based downlink (DL) positioning for outside of a measurement gap. Although the devices discussed below and shown in the figures refer to 5G or Next Generation NodeB (gNB) devices and user equipment (UE) devices, this disclosure is not limited to only gNBs and UEs.

It may be readily understood that the components of certain example embodiments, as generally described and illustrated in the figures herein, may be arranged and designed in a wide variety of different configurations. Different reference designations from multiple figures may be used out of sequence in the description, to refer to a same element to illustrate their features or functions. If desired, the different functions or procedures discussed herein may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

In 5G/NR technology, as well as LTE, positioning is performed by transmitting/receiving signals between a user equipment (UE) and a network entity, such as a location server or location management function (LMF). NR positioning may support carrier aggregation (CA) using positioning reference signals (PRS) and/or sounding reference signals (SRS). CA may be designed to support aggregation of a variety of different arrangements of component carriers, including component carriers of the same or different bandwidths, adjacent or non-adjacent component carriers in the same frequency band, component carriers of the same or different numerologies, and component carriers in different frequency bands.

The UE may be configured for CA to connect to a primary serving cell (PCell) and at least one secondary serving cell (SCell). Carrier aggregation may perform positioning measurements across up to three intra-band contiguous carriers [RAN1, RAN2, RAN4]. The UE may use measurement gaps to perform intra-frequency, inter-frequency and inter-radio access technology (RAT) measurements. The NR network may support a measurement gap dedicated for positioning measurement so that the UE may perform a DL PRS measurement without consideration of other reference signals or channels from a serving cell, such as a gNB. For example, the UE does not need to receive a Physical Downlink Shared Channel (PDSCH) from the serving cell to perform PRS measurements.

One or more measurement gaps may be dedicated for a positioning measurement so that the UE may focus on a downlink (DL) PRS measurement without considering other reference signals or channels from the serving cell. In a situation in which a positioning measurement needs to be performed outside of the measurement gap or there are no measurement gaps, the network may provide a PRS processing window (PPW) for the UE to measure DL PRS within the time period of the PPW. Within the PPW, the UE may be prioritized or configured to have a relatively higher priority on the DL PRS measurement and reception of other channels.

The PPW may be used by the UE to measure DL PRS outside of the measurement gap configuration, and a PPW configuration is bandwidth part (BWP) specific. For example, “PRS-Processing WindowPreconfig” may be included in a “BWP-DownlinkDedicated,” which may be defined, for example, in TS 38.331 Radio Resource Control (RRC) specification. The UE may use different PPWs to measure PRS in different component carriers.

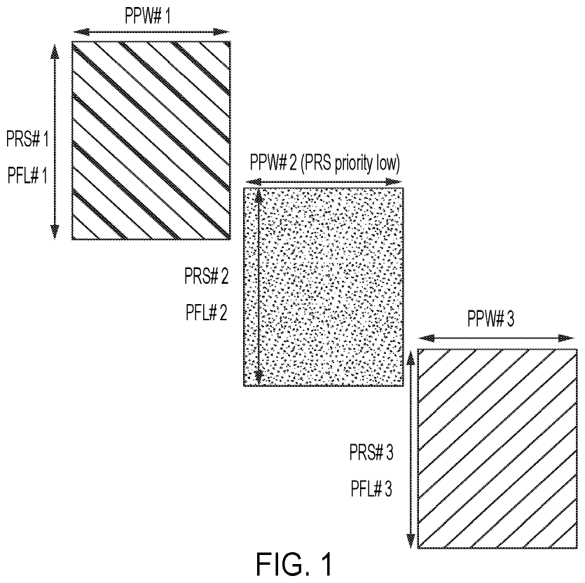

The PPW configuration may have a PRS priority indication/configuration. The reception of other channels, such as a PDSCH, may be configured as higher priority than the PRS measurement. Thus, the UE may miss or be unable to obtain measurements for a specific PRS resource for a specific positioning frequency layer (PFL). For example, the UE may miss or be unable to perform a DL PRS measurement within a PPW with respect to its BWP. Some PRS measurements within certain PPWs may not be able to be obtained by the UE as indicated by the LMF/gNB (network) due to priority configurations. For example, as explained below with respect to FIG. 1, the LMF may indicate to the UE to report a PRS measurement by CA from PFL #1,PFL #2, and PFL #3, but the UE may miss PFL #2.

FIG. 1 illustrates an example of CA-based positioning is attempted outside of the measurement gap without being able to accurately obtain positioning measurements from aggregated PRSs. FIG. 1 shows three instances for measurement by a UE, which are PPW #1/PFL #1, PPW #2/PFL #2, and PPW #3/PFL #3. In this example, PPW #2/PFL #2 may be set as a low/lower priority on PRS reception compared to PPW #1 /PFL #1 and PPW #3/PFL #3. When the UE attempts to perform PRS measurements for PPW #1/PFL #1, PPW #2/PFL #2, and PPW #3/PFL #3, the UE may be unable to obtain PRS #2 because the reception of PRS #2 in PPW #2/PFL #2 has a low priority. In this situation, the UE may still obtain PRS #1 and PRS #3, but the UE will be unable to accurately obtain and provide a positioning measurement from an aggregated PRS bandwidth across three PFLs because the UE may not be able to obtain PRS #2. This may render the positioning measurement inaccurate. The LMF may have a target requirement for the positioning measurement which can be attained by aggregating three PRS bandwidth, but the UE may be unable to provide the required positioning measurement.

To support intra-band CA-based positioning, there may be a need for NR positioning to provide a signalling such that an LMF indicates or requests the UE to report DL PRS measurement for multiple (e.g., two) PRS resources that are transmitted on the consecutive component carriers, such as two component carriers, since the UE may not be mandated to report positioning measurement based on CA. Similarly, for the uplink, the LMF may be able to request the gNB to report UL positioning measurements by CA for the two SRS resources transmitted over the two consecutive component carriers. Outside of the measurement gap configuration, even if the LMF indicates the UE to report the positioning measurement for the aggregated bandwidth of the PRS resources across PFLs, it is not guaranteed that the UE can report it, since the UE can miss the measurement depending on the priority configuration (see example in FIG. 1). Conventionally, the UE reported measurement per PFL, so there was no process for the UE to report a positioning measurement obtained from multiple PFLs for both inside and outside of the measurement gap.

Various exemplary embodiments may provide advantages to resolve issues known in the technology, such as the issues discussed above. For example, certain exemplary embodiments may advantageously provide one or more procedures to for a UE perform reporting when the UE cannot obtain CA based positioning measurement for the multiple PFLs as indicated by a radio network when outside a measurement gap. Certain exemplary embodiments may solve a need for new signaling such that the LMF may request the UE to report a single positioning measurement (e.g., reference signal time different (RSTD)) which may be obtained by aggregation of multiple PFLs.

Within the measurement gap, the UE may only focus on DL PRS measurement, so a properly implemented UE may receive PRS over multiple PFLs. The UE may be able to extract a single measurement by aggregating PRS resources over multiple PFLs. Outside of the measurement gap, it is not guaranteed that the UE may focus on DL PRS measurement, which may result in the UE missing or failing to obtain measurements. Various exemplary embodiments discussed herein may be directed to resolving this concern in the situation outside of the measurement gap.

Certain exemplary embodiments may provide an LMF that may indicate or request the UE to report a positioning measurement for the aggregated component carriers. The LMF may indicate two or more of specific frequency layer IDs, TRP ID, and PRS resource set ID(s), and PRS resource ID(s). This reporting indication may be different from the current indication for the measurement reporting. The measurement reporting may be jointly associated with two or more frequency layers. The UE may attempt to measure the PRS resources for the indicated positioning frequency layers using the configured PRS processing window(s), and to obtain measurement by coherent combining of PRS resources transmitted by CA. The UE may successfully measure PRSs for the indicated PFL and proceed with processing the measurements

Various exemplary embodiments may be directed to providing one or more procedures for when the UE may fail to measure one or more of the PRS resources for one specific PFL, some PFLs, or all PFLs. In each of these situations in which the UE fails to measure one or more of the PRS resources, the LMF may provide the UE with positioning assistance information by LTE positioning protocol (LPP) including PRS configuration and TRP information. The LMF may also provide the PRS configuration information to the gNB by, for example, NR Positioning Protocol-a (NRPPa).

The gNB may configure one or more PPWs over multiple PFLs to the UE. The PFLs may be transmitted or provided separately/individually in time or concurrently. The LMF may indicate to or request that the UE report a positioning measurement for the aggregated carriers. The LMF may also indicate two or more of the specific frequency layer IDs, TRP ID, and PRS resource set ID(s), and PRS resource ID(s), which may be a different indication than the indication by the LMF for the positioning measurement reporting. The positioning measurement reporting may be jointly associated with two or more frequency layers. The UE may perform a measurement procedure to attempt to measure the PRS resources for the indicated PFLs using the configured PPWs, and to obtain measurement by coherent combining of PRS resources transmitted by CA. The UE may attempt to obtain a single positioning measurement by aggregating multiple PRS resources. However, the UE could fail to measure one or more of the PRS resources for the specific PFLs.

The UE may successfully obtain a positioning measurement from a part of the indicated frequency layers, and thus a single positioning measurement may be successfully obtained by CA. In certain exemplary embodiments, there may be a situation in which the UE may not be able to perform the positioning measurement for one or more of the indicated PFLs. In this situation, the UE may perform one or more procedures discussed below, according to various exemplary embodiments.

According to various exemplary embodiments, a non-limiting example of a procedure performed by the UE may be for the UE to report a single positioning measurement obtained from a part of the indicated PFLs, such as a positioning measurement, PFL ID(s), and TRP ID. In some exemplary embodiments, the UE may obtain positioning measurements by aggregating PRS resources for some PFLs, but not all PFLs, and transmit a single positioning measurement to the LMF based on the partially aggregated PRS resources by CA. The UE may not report any other related information. The LMF may not be able to determine if the reported measurement is from CA or not, which may be needed for a minimum reporting overhead, because, for example, the UE may report the positioning measurement without additional information about where or how the measurement was obtained.

According to some exemplary embodiments, another non-limiting example of a procedure performed by the UE may be for the UE to report a positioning measurement obtained from a part of the indicated PFLs and may also report a set of PFL ID(s) and PPW ID(s) that the UE failed to measure. The LMF may need to know which PFL that the UE failed to measure and the PPW ID used for the PFL. The LMF may also need to be informed of the PFL that the UE failed to measure and the PPW ID used for the PFL. Additionally, the LMF may be able to request the gNB to provide a new PPW to the target UE based on the PFL and the PPW ID reported by the UE. For example, the LMF may request the gNB to configure high priority of PRS reception in this PPW.

In the event that the number of failed measurements is greater than the number of successful measurements, the UE may, for example, report the positioning measurement obtained from a part of the indicated PFLs, and also report a set of PFL ID(s) and PPW ID(s)) that the UE successfully measured, according to some exemplary embodiments. If there is an equal number of failed and successful measurements, the UE may initially be configured to either (i) report a positioning measurement obtained from a part of the indicated PFLs and a set of PFL ID(s) and PPW ID(s) that the UE failed to measure, or (ii) report the positioning measurement obtained from a part of the indicated PFLs and a set of PFL ID(s) and PPW ID(s)) that the UE successfully measured. The UE may subsequently be re-configured to follow the other of these procedures.

By the UE reporting the positioning measurement obtained from a part of the indicated PFLs a set of PFL ID(s) and PPW ID(s)) that the UE successfully measured, in the event that the number of failed measurements is greater than the number of successful measurements, the reporting overhead may be reduced. Once the positioning measurements and a set of PFL and PPW IDs are received, the LMF may infer/determine whether the reported set of PFL and PPW IDs is a list of failed or successful measurements. For example, if the number of reported positioning measurements equals to the number of the reported PLF/PPW IDs, the reported set may be a list of successful measurements.

According to various exemplary embodiments, another non-limiting example of a procedure performed by the UE may be for the UE to not report any positioning measurement and instead report a set of PFL ID(s) and PPW ID(s)) that the UE failed to measure. Without CA, a measurement accuracy may not be satisfactory for the LMF, and thus, the measurement reporting might be unnecessary.

According to certain exemplary embodiments, another non-limiting example of a procedure performed by the UE may be for the UE to report the positioning measurement(s) and report whether the positioning measurement(s) is from the aggregated PRS resources or not. The LMF may need to know whether the reported measurement is obtained by CA.

The procedures performed by the UE, such as the non-limiting examples discussed herein, may correspond to a configured PPW when the UE may be indicated to report the PRS measurement by CA. If the UE may drop specific PRS resources for a PFL within a PRS processing window due to a priority rule, the UE may then follow a rule set for all PPWs for other PFLs. If the UE may drop PRS resources in PPW in one PFL, then the UE may stop receiving PRS resources over all the concurrent PPWs in all the PFLs. Further, the UE may not be able to meet accuracy requirements of the PRS measurement, so the UE may stop all related measurement procedures. If the UE cannot obtain a single measurement from any consecutive two PFLs, the UE may drop all PPWs in all PFLs.

In some exemplary embodiments, the UE may report a PFL ID or a PPW ID, in case either may fail to obtain measurement in order to take positioning measurements by the gNB. The LMF may request the gNB to configure new PPW for a PFL with a different length (time), periodicity, or priority, so that the UE may measure multiple PFLs for CA. In addition, or as an alternative, the LMF may request the gNB to configure high priority on the PRS measurement to the PPW for a PFL reported by the UE. The LMF may accordingly estimate a location of the UE.

According to some exemplary embodiments, when the UE may not be able to obtain the measurement by aggregating the PRSs for the indicated PFLs, the UE may report a single positioning measurement according to configured rules. The configured rules may be based on resource block size of DL PRS resource, reference signal received power (RSRP), and/or measurement quality. For example, for the successfully measured PRS resources, the UE may select a PRS resource occupied with the largest resource blocks for the measurement reporting.

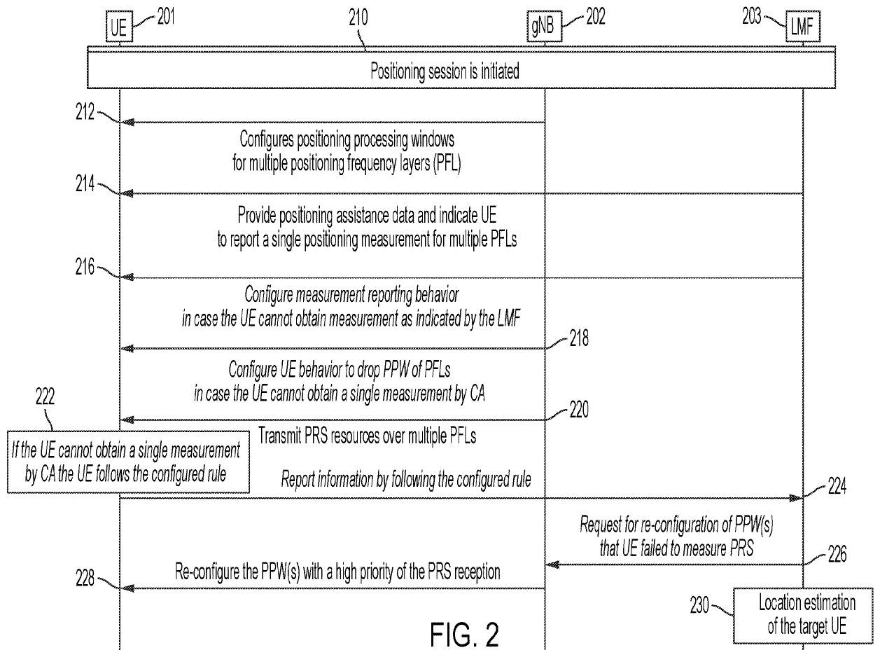

FIG. 2 illustrates an exemplary procedure CA-based positioning of a UE. At 210, a positioning session may be initiated between a UE 201, a gNB 202, and an LMF 203. At 212, the gNB 102 may configure, for the UE 201, PPWs for multiple PFLs. At 214, the LMF 203 may provide positioning assistance data to the UE 201 and may indicate to the UE 201 to report a single positioning measurement for multiple PFLs. At 216, the LMF 203 may configure, for the UE 201, a measurement reporting procedure for a case in which the UE 201 may not be able to obtain measurements as indicated by the LMF 203.

At 218, the gNB 202 may configure a procedure for the UE 201 to drop PPWs of the PFLs in the case in which the UE 201 cannot obtain a single measurement by CA. At 220, the gNB 202 may transmit, to the UE 201, PRS resources over multiple PFLs. At 222, the UE 201 may perform the procedure configured at 218 when the UE 201 cannot obtain a single measurement by CA. At 224, the UE 201 may report, to the LMF 203, information according to the procedure configured at 218 by the gNB 202.

At 226, the LMF 203 may request that the gNB 202 reconfigure and/or adjust the priority of one or more PPWs that the UE 201 failed to measure PRS. At 228, the gNB 202 may reconfigure, for the UE 201, the one or more PPWs, as requested by the LMF at 226, with a high/higher priority of PRS reception. The UE 201 may use the reconfigured PPWs to again attempt to perform positioning measurement and reporting of the PFL that previously failed. At 230, the LMF 203 may perform a location estimation of the UE 201 based on the information reported by the UE 201.

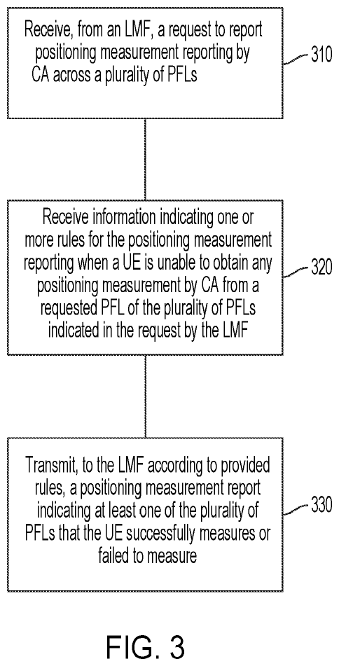

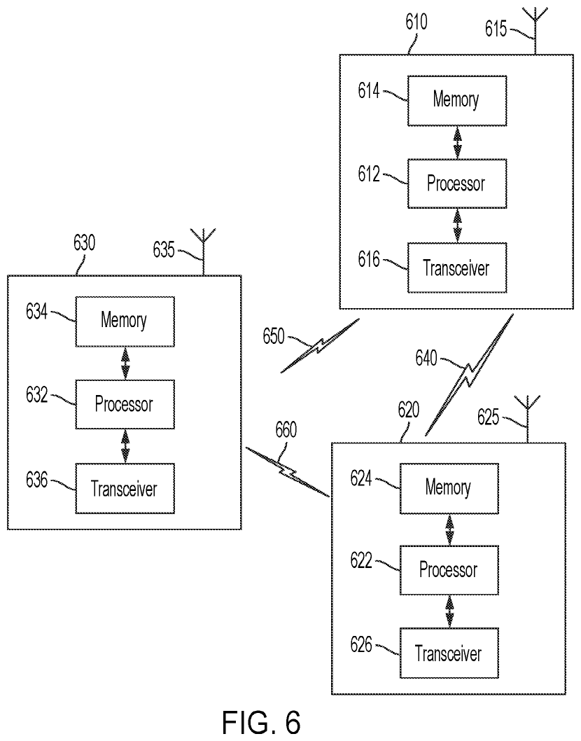

FIG. 3 illustrates an example flow diagram of a method, according to certain exemplary embodiments. In an example embodiment, the method of FIG. 3 may be performed by a network element, or a group of multiple network elements in a 3GPP system, such as LTE or 5G-NR. For instance, in an exemplary embodiment, the method of FIG. 3 may be performed by a network device or user device, such as a UE, similar to UE 201 illustrated in FIG. 2 and apparatus 610 illustrated in FIG. 6.

According to various exemplary embodiments, the method of FIG. 3 may include, at 310, receiving (similar to 214 in FIG. 2), from an LMF similar to LMF 203 in FIG. 2 and apparatus 630 in FIG. 6, a request to report positioning measurement reporting by carrier aggregation across a plurality of positioning frequency layers (PFLs). At 320, the method may also include receiving (similar to 216 in FIG. 2) information indicating one or more rules for the positioning measurement reporting applied at the apparatus 610 (similar to UE 201) when the apparatus 610 (similar to UE 201) is unable to obtain any positioning measurement by carrier aggregation (CA) from a requested PFL of the plurality of PFLs indicated in the request by the LMF (similar to LMF 203 in FIG. 2 and apparatus 630 in FIG. 6).

At 330, the method may further include transmitting (similar to 224 in FIG. 2), to the LMF (similar to LMF 203 in FIG. 2 and apparatus 630 in FIG. 6) according to provided rules, a positioning measurement report indicating at least one of the plurality of PFLs that the apparatus 610 (similar to UE 201) successfully measures or failed to measure.

In certain exemplary embodiments, the rules may be provided by the LMF (similar to LMF 203 in FIG. 2 and apparatus 630 in FIG. 6), to configure the apparatus 610 (similar to UE 201) with the plurality of positioning frequency layers (PFLs) and one or more positioning reference signal processing windows (PPW), wherein each PPW is associated with a respective positioning frequency layer (PFL).

In some exemplary embodiments, the rules may configure the apparatus 610 (similar to UE 201) to perform one or more of: reporting that a set of a positioning measurement, a positioning frequency layer identifier (PFL ID), and a transmission reception point (TRP) ID, are successfully measured by the apparatus 610 (similar to UE 201); reporting a set of the PFL ID and a PPW ID that the apparatus 610 (similar to UE 201) has failed to measure; reporting the set of the PFL ID and the PPW ID that the apparatus 610 (similar to UE 201) has successfully measured, when a quantity of successfully measured positioning frequency layers (PFLs) is less than a quantity of positioning frequency layers (PFLs) that the apparatus 610 (similar to UE 201) has failed to measure; reporting the positioning measurement only when the reported positioning measurement is obtained by the carrier aggregation and not across all of the plurality of positioning frequency layers (PFLs); and reporting the positioning measurement, the PFL IDs, and the TRP ID, which are obtained by carrier aggregation from at least a portion of the plurality of positioning frequency layers (PFLs).

In certain exemplary embodiments, positioning reference resources may be transmitted from a transmission reception point (TRP) over the plurality of positioning frequency layers (PFLs).

In some exemplary embodiments, when the apparatus 610 (similar to UE 201) is configured by rules provided by a network node (see 218 in FIG. 2) to drop receiving specific PRS resources within a PPW for one positioning frequency layer (PFL), the method may further include dropping receiving PRS resources over all concurrent PPWs in all of the plurality of positioning frequency layers (PFLs).

In various exemplary embodiments, when the apparatus 610 (similar to UE 201) is further configured by the rules provided by the network node (see 220 in FIG. 2) not to obtain the positioning measurement by the carrier aggregation from any two consecutive positioning frequency layers (PFLs), the method may further include dropping receiving PRS resources in all PPWs in all of the plurality of positioning frequency layers (PFLs).

Some exemplary embodiments may provide that the positioning measurement report includes one or more positioning measurements obtained from at least a part of the plurality of positioning frequency layers (PFLs). Further, the positioning measurement report includes no positioning measurement.

In various exemplary embodiments, the method may further include transmitting, in the positioning measurement report, at least one identifier for each positioning frequency layer (PFL) and PPW in which the measurement failed, or at least an indication of a failure event to obtain positioning measurement by carrier aggregation (CA).

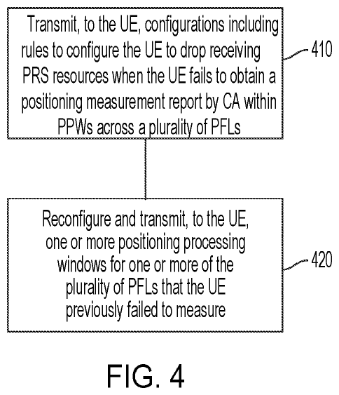

FIG. 4 illustrates an example flow diagram of a method, according to certain exemplary embodiments. In an example embodiment, the method of FIG. 4 may be performed by a network element, or a group of multiple network elements in a 3GPP system, such as LTE or 5G-NR. For instance, in an exemplary embodiment, the method of FIG. 4 may be performed by a network device or network entity, such as a base station or gNB, similar to the gNB 202 in FIG. 2 and apparatus 620 illustrated in FIG. 6.

According to various exemplary embodiments, the method of FIG. 4 may include, at 410, transmitting (similar to 216 in FIG. 2), to a UE (similar to UE 201 and apparatus 610), configurations including rules to configure the UE (similar to UE 201 and apparatus 610) to drop receiving PRS resources when the UE (similar to UE 201 and apparatus 610) fails to obtain a positioning measurement report by CA within PPWs across a plurality of PFLs. The method may also include, at 420, reconfiguring and transmitting (similar to 216 in FIG. 2), to the UE (similar to UE 201 and apparatus 610), one or more PPWs for one or more of the plurality of PFLs that the UE (similar to UE 201 and apparatus 610) previously failed to measure.

In certain exemplary embodiments, the method may further include transmitting positioning reference resources over the plurality of PFLs. According to some exemplary embodiments, the rules may configure the UE such that when the UE drops receiving specific PRS resources within a PPW for one PFL, the rules may configure the UE to drop receiving PRS resources over all concurrent PPWs in all of the plurality of PFLs.

In some exemplary embodiments, the rules may configure the UE such that, when the UE cannot obtain the positioning measurement by the carrier aggregation (CA) from any two consecutive PFLs, the rule may configure the UE to drop receiving PRS resources in all PPWs in all of the plurality of PFLs.

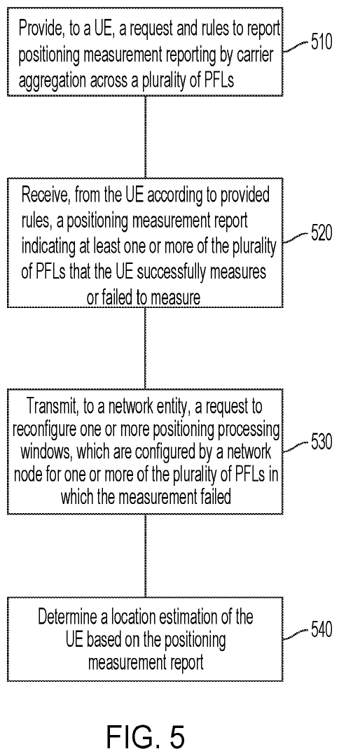

FIG. 5 illustrates an example flow diagram of a method, according to certain exemplary embodiments. In an example embodiment, the method of FIG. 5 may be performed by a network element, or a group of multiple network elements in a 3GPP system, such as LTE or 5G-NR. For instance, in an exemplary embodiment, the method of FIG. 5 may be performed by a network or network entity, such as an LMF, similar to LMF 203 in FIG. 2 and apparatus 630 illustrated in FIG. 6.

According to various exemplary embodiments, the method of FIG. 5 may include, at 510, providing (similar to 214 in FIG. 2), to a UE (similar to UE 201 and apparatus 610), a request and rules to report positioning measurement reporting by carrier aggregation (CA) across a plurality of PFLs. The method may also include, at 520, receiving (similar to 224 in FIG. 2), from the UE (similar to UE 201 and apparatus 610) according to the provided rules, a positioning measurement report indicating at least one or more of the plurality of PFLs that the UE (similar to UE 201 and apparatus 610) successfully measures or failed to measure.

According to some exemplary embodiments, the method may further include, at 530, transmitting (similar to 226 in FIG. 2), to a network entity (similar to gNB 202 and apparatus 620), a request to reconfigure one or more PPWs, which are configured by a network node (similar to the gNB 202 in FIG. 2 and apparatus 620) for one or more of the plurality of PFLs in which the measurement failed. The method may also include, at 540, determining a location estimation (similar to 230 in FIG. 2) of the UE (similar to UE 201 and apparatus 610) based on the positioning measurement report.

In certain exemplary embodiments, the provided rules may configure the UE (similar to UE 201 and apparatus 610) with the plurality of PFLs and one or more positioning reference signal processing windows (PPWs). Each PPW may be associated with a respective PFL.

In some exemplary embodiments, the positioning measurement report comprises one or more of: a set of a positioning measurement, a PFL identifier (ID), and a transmission reception point (TRP) ID, that are successfully measured by the UE (similar to UE 201 and apparatus 610); a set of the PFL ID and a PPW ID that the UE (similar to UE 201 and apparatus 610) failed to measure; the set of the PFL ID and the PPW ID that the UE (similar to UE 201 and apparatus 610) successfully measured, when a quantity of successfully measured PFLs is less than a quantity of PFLs that the UE (similar to UE 201 and apparatus 610) failed to measure; the positioning measurement only when the reported positioning measurement is obtained by the carrier aggregation (CA) and not across all of the plurality of PFLs; and the positioning measurement, the PFL IDs, and the TRP ID, which are obtained by carrier aggregation (CA) from at least a portion of the plurality of PFLs.

Various exemplary embodiments may provide that the positioning measurement report includes either no positioning measurement or at least an indication of a failure event of the UE (similar to UE 201 and apparatus 610) to obtain positioning measurement by carrier aggregation (CA) from a requested PFL of the plurality of PFLs.

FIG. 6 illustrates apparatuses 610, 620, and 630 according to various exemplary embodiments. In the various exemplary embodiments, apparatus 610 may be an element in a communications network or associated with such a network, such as a UE, RedCap UE, SL UE, mobile equipment (ME), mobile station, mobile device, stationary device, IoT device, or other device. UE 201 may be an example of apparatus 630 according to various exemplary embodiments as discussed above. It should be noted that one of ordinary skill in the art would understand that apparatus 610 may include components or features not shown in FIG. 6. Further, the apparatus 620 may be a network entity, element of the core network, or element in a communications network or associated with such a network, such as a base station, an NE, or a gNB. For example, gNB 202 may be an example of apparatus 620 according to various exemplary embodiments as discussed above. It should be noted that one of ordinary skill in the art would understand that apparatus 620 may include components or features not shown in FIG. 6. In addition, the apparatus 630 may be a part of the RAN, a network entity or a sub-component or processing functions of a network entity of computation device connected to the network, such as an LMF. For example, LMF 203 may be an example of apparatus 630 according to various exemplary embodiments as discussed above. It should be noted that one of ordinary skill in the art would understand that apparatus 630 may include components or features not shown in FIG. 6.

According to various exemplary embodiments, the apparatuses 610, 620, and/or 630 may include one or more processors, one or more computer-readable storage medium (for example, memory, storage, or the like), one or more radio access components (for example, a modem, a transceiver, or the like), and/or a user interface. In some exemplary embodiments, apparatuses 610, 620, and/or 630 may be configured to operate using one or more radio access technologies, such as GSM, LTE, LTE-A, NR, 5G, WLAN, WiFi, NB-IoT, Bluetooth, NFC, MulteFire, and/or any other radio access technologies.

As illustrated in the example of FIG. 6, apparatuses 610, 620, and/or 630 may include or be coupled to processors 612, 622, and 632, respectively, for processing information and executing instructions or operations. Processors 612, 622, and 632 may be any type of general or specific purpose processor. In fact, processors 612, 622, and 632 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 612 (622 and 632) for each of apparatuses 610, 620, and/or 630 is shown in FIG. 6, multiple processors may be utilized according to other example embodiments. For example, it should be understood that, in certain example embodiments, apparatuses 610, 620, and/or 630 may include two or more processors that may form a multiprocessor system (for example, in this case processors 612, 622, and 632 may represent a multiprocessor) that may support multiprocessing. According to certain example embodiments, the multiprocessor system may be tightly coupled or loosely coupled to, for example, form a computer cluster).

Processors 612, 622, and 632 may perform functions associated with the operation of apparatuses 610, 620, and/or 630, respectively, including, as some examples, precoding of antenna gain/phase parameters, encoding and decoding of individual bits forming a communication message, formatting of information, and overall control of the apparatuses 610, 620, and/or 630, including processes illustrated in FIGS. 2-5.

Apparatuses 610, 620, and/or 630 may further include or be coupled to memory 614, 624, and/or 634 (internal or external), respectively, which may be coupled to processors 612, 622, and 632, respectively, for storing information and instructions that may be executed by processors 612, 622, and 632. Memory 614 (memory 624 and 634) may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 614 (memory 624 and 634) can be comprised of any combination of random access memory (RAM), read only memory (ROM), static storage such as a magnetic or optical disk, hard disk drive (HDD), or any other type of non-transitory machine or computer readable media. The instructions stored in memory 614, memory 624, and memory 634 may include program instructions or computer program code that, when executed by processors 612, 622, and 632, enable the apparatuses 610, 620, and/or 630 to perform tasks as described herein.

In certain example embodiments, apparatuses 610, 620, and/or 630 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processors 612, 622, and 632 and/or apparatuses 610, 620, and/or 630 to perform any of the methods illustrated in FIGS. 2-5.

In some exemplary embodiments, apparatuses 610, 620, and/or 630 may also include or be coupled to one or more antennas 615, 625, and 635, respectively, for receiving a downlink signal and for transmitting via an uplink from apparatuses 610, 620, and/or 630. Apparatuses 610, 620, and/or 630 may further include transceivers 616, 626, and 636, respectively, configured to transmit and receive information. The transceivers 616, 626, and 636 may also include a radio interface (for example, a modem) respectively coupled to the antennas 615, 625, and 635. The radio interface may correspond to a plurality of radio access technologies including one or more of GSM, LTE, LTE-A, 5G, NR, WLAN, NB-IOT, Bluetooth, BT-LE, NFC, RFID, UWB, or the like. The radio interface may include other components, such as filters, converters (for example, digital-to-analog converters or the like), symbol demappers, signal shaping components, an Inverse Fast Fourier Transform (IFFT) module, or the like, to process symbols, such as OFDMA symbols, carried by a downlink or an uplink.

For instance, transceivers 616, 626, and 636 may be respectively configured to modulate information on to a carrier waveform for transmission by the antenna(s) 615, 625, and 635, and demodulate information received via the antenna(s) 615, 625, and 635 for further processing by other elements of apparatuses 610, 620, and/or 630. In other example embodiments, transceivers 616, 626, and 636 may be capable of transmitting and receiving signals or data directly. Additionally or alternatively, in some example embodiments, apparatuses 610, 620, and/or 630 may include an input and/or output device (I/O device). In certain example embodiments, apparatuses 610, 620, and/or 630 may further include a user interface, such as a graphical user interface or touchscreen.

In certain example embodiments, memory 614, memory 624, and memory 634 store software modules that provide functionality when executed by processors 612, 622, and 632, respectively. The modules may include, for example, an operating system that provides operating system functionality for apparatuses 610, 620, and/or 630. The memory may also store one or more functional modules, such as an application or program, to provide additional functionality for apparatuses 610, 620, and/or 630. The components of apparatuses 610, 620, and/or 630 may be implemented in hardware, or as any suitable combination of hardware and software. According to certain example embodiments, apparatus 610 may optionally be configured to communicate with apparatus 620 and/or 630 via a wireless or wired communications links 640, 650, and/or 660 according to any radio access technology, such as NR.

According to certain example embodiments, processors 612, 622, and 632, and memory 614, 624, and 634 may be included in or may form a part of processing circuitry or control circuitry. In addition, in some example embodiments, transceivers 616, 626, and 636 may be included in or may form a part of transceiving circuitry.

For instance, in certain exemplary embodiments, the apparatus 610 (similar to UE 201) may be controlled by the memory 614 and the processor 612 to receive (similar to 214 in FIGS. 2 and 310 in FIG. 3), from an LMF (similar to LMF 203 in FIG. 2 and apparatus 630 in FIG. 6), a request to report positioning measurement reporting by CA across a plurality of PFLs. The apparatus (similar to UE 201) may also be caused to transmit (similar to 224 in FIGS. 2 and 330 in FIG. 3), to the LMF (similar to LMF 203 in FIG. 2 and apparatus 630 in FIG. 6) according to provided rules, a positioning measurement report indicating at least one or more of the plurality of PFLs that the apparatus 610 (similar to UE 201) successfully measures or failed to measure.

In various exemplary embodiments, the apparatus 620 (similar to gNB 202 in FIG. 2) may be controlled by the memory 624 and the processor 622 to transmit (similar to 216 in FIGS. 2 and 410 in FIG. 4), to a UE (similar to UE 201 and apparatus 610), configurations comprising rules to configure the UE (similar to UE 201 and apparatus 610) to drop receiving PRS resources when the UE (similar to UE 201 and apparatus 610) fails to obtain a positioning measurement report by CA within PPW across a plurality of PFLs. The apparatus (similar to gNB 202 in FIG. 2) may also be caused to reconfigure and transmit (similar to 216 in FIGS. 2 and 420 in FIG. 4), to the UE (similar to UE 201 and apparatus 610), one or more PPWs for one or more of the plurality of PFLs that the UE (similar to UE 201 and apparatus 610) previously failed to measure.

In various exemplary embodiments, the apparatus 630 (similar to LMF 203 in FIG. 2) may be controlled by the memory 634 and the processor 632 to provide (similar to 214 in FIGS. 2 and 510 in FIG. 5), to a UE (similar to UE 201 and apparatus 610), a request and rules to report positioning measurement reporting by CA across a plurality of PFLs. The apparatus (similar to LMF 203 in FIG. 2) may also be caused to receive (similar to 224 in FIGS. 2 and 520 in FIG. 5), from the UE (similar to UE 201 and apparatus 610) according to the provided rules, a positioning measurement report indicating at least one or more of the plurality of PFLs that the UE (similar to UE 201 and apparatus 610) successfully measures or failed to measure.

In some exemplary embodiments, an apparatus (e.g., apparatus 610, apparatus 620, and/or apparatus 630) may include means for performing a method, a process, or any of the variants discussed herein. Examples of the means may include one or more processors, memory, controllers, transmitters, receivers, and/or computer program code for causing the performance of the operations.

Various exemplary embodiments may be directed to an apparatus, such as apparatus 610, that may include means for receiving, from an LMF, a request to report positioning measurement reporting by CA across a plurality of PFLs, and means for transmitting, to the LMF according to provided rules, a positioning measurement report indicating at least one of the plurality of PFLs that the apparatus 610 successfully measures or failed to measure.

Various exemplary embodiments may be directed to an apparatus, such as apparatus 620, that may include means for transmitting, to a UE, configurations including first rules to configure the UE to drop receiving PRS resources when the UE fails to obtain a positioning measurement report by CA within PPWs across a plurality of PFLs, and means for reconfiguring and transmitting, to the UE, one or more PPWs for one or more of the plurality of PFLs that the UE previously failed to measure.

Various exemplary embodiments may be directed to an apparatus, such as apparatus 630, that may include means for providing, to a UE, a request and rules to report positioning measurement reporting by CA across a plurality of PFLs, and means for receiving, from the UE according to the provided rules, a positioning measurement report indicating at least one or more of the plurality of PFLs that the UE successfully measures or failed to measure.

As used herein, the term “circuitry” may refer to hardware-only circuitry implementations (for example, analog and/or digital circuitry), combinations of hardware circuits and software, combinations of analog and/or digital hardware circuits with software/firmware, any portions of hardware processor(s) with software, including digital signal processors, that work together to cause an apparatus (for example, apparatus 610, 620, and/or 630) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor or multiple processors, or portion of a hardware circuit or processor, and the accompanying software and/or firmware. The term circuitry may also cover, for example, a baseband integrated circuit in a server, cellular network node or device, or other computing or network device.

A computer program product may include one or more computer-executable components which, when the program is run, are configured to carry out some example embodiments. The one or more computer-executable components may be at least one software code or portions of it. Modifications and configurations required for implementing functionality of certain example embodiments may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (for example, apparatuses 610, 620, and/or 630), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to certain example embodiments, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily refer to the same group of embodiments, and the described features, structures, or characteristics may be combined in any suitable manner in one or more example embodiments. Further, the terms “cell”, “node”, “gNB”, or other similar language throughout this specification may be used interchangeably.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

One having ordinary skill in the art will readily understand that the disclosure as discussed above may be practiced with procedures in a different order, and/or with hardware elements in configurations which are different than those which are disclosed. Therefore, although the disclosure has been described based upon these example embodiments, it would be apparent to those of skill in the art that certain modifications, variations, and alternative constructions would be apparent, while remaining within the spirit and scope of example embodiments. Although the above embodiments refer to 5G NR and LTE technology, the above embodiments may also apply to any other present or future 3GPP technology, such as LTE-advanced, and/or fourth generation (4G) technology.

### PARTIAL GLOSSARY

3GPP 3rd Generation Partnership Project
5G 5th Generation
CA Carrier Aggregation
CE Control Element
DL Downlink
EMBB Enhanced Mobile Broadband
eNB 4G/LTE Base Station/NodeB
gNB 5G or Next Generation NodeB
LMF Location Management Function
LPP LTE Positioning Protocol
LTE Long Term Evolution
NR New Radio
PDCCH Physical Downlink Control Channel
PDSCH Physical Downlink Shared Channel
PFL Positioning Frequency Layer
PPW PRS Processing Window
PRS Positioning Reference Signal
PUSCH Physical Uplink Shared Channel
RAN Radio Access Network
RedCap Reduced Capability
RRC Radio Resource Control
RSTD Reference Signal Time Difference
SRS Sounding Reference Signal
TDOA Time Difference of Arrival
TRP Transmission Reception Point
UE User Equipment
UL Uplink
URLLC Ultra Reliable Low Latency Communication

1. An apparatus comprising:
at least one processor; and
at least one memory storing instructions that, when executed by the at least one processor, cause the apparatus at least to:
receive, from a location management function, a request to report positioning measurement reporting by carrier aggregation across a plurality of positioning frequency layers (PFLs); and
transmit, to the location management function according to provided rules, a positioning measurement report indicating at least one of the plurality of positioning frequency layers (PFLs) that the apparatus successfully measures or failed to measure.

2. The apparatus according to claim 1, wherein the rules are provided by the location management function, to configure the apparatus with the plurality of positioning frequency layers (PFLs) and one or more positioning reference signal processing windows (PPW), wherein each PPW is associated with a respective positioning frequency layer (PFL).

3. The apparatus according to claim 1, wherein the rules configure the apparatus to perform one or more of:
reporting that a set of a positioning measurement, a positioning frequency layer identifier (PFL ID), and a transmission reception point (TRP) ID, are successfully measured by the apparatus;
reporting a set of the PFL ID and a PPW ID that the apparatus has failed to measure;
reporting the set of the PFL ID and the PPW ID that the apparatus has successfully measured, when a quantity of successfully measured positioning frequency layers (PFLs) is less than a quantity of positioning frequency layers (PFLs) that the apparatus has failed to measure;
reporting the positioning measurement only when the reported positioning measurement is obtained by the carrier aggregation and not across all of the plurality of positioning frequency layers (PFLs); and
reporting the positioning measurement, the PFL IDs, and the TRP ID, which are obtained by carrier aggregation from at least a portion of the plurality of positioning frequency layers (PFLs).

4. The apparatus according to claim 1, wherein positioning reference resources are transmitted from a transmission reception point (TRP) over the plurality of positioning frequency layers (PFLs).

5. The apparatus according to claim 1, wherein, when the apparatus is configured by rules provided by a network node to drop receiving specific PRS resources within a PPW for one positioning frequency layer (PFL), the apparatus is further configured by the rules provided by the network node to drop receiving PRS resources over all concurrent PPWs in all of the plurality of positioning frequency layers (PFLs).

6. The apparatus according to claim 1, wherein, when the apparatus is further configured by the rules provided by the network node not to obtain the positioning measurement by the carrier aggregation from any two consecutive positioning frequency layers (PFLs), the apparatus is further caused to drop receiving PRS resources in all PPWs in all of the plurality of positioning frequency layers (PFLs).

7. The apparatus according to claim 1, wherein the positioning measurement report comprises one or more positioning measurements obtained from at least a part of the plurality of positioning frequency layers (PFLs).

8. The apparatus according to claim 1, wherein the positioning measurement report comprises no positioning measurement.

9. The apparatus according to claim 2, wherein the apparatus is further caused to:
receive information indicating one or more rules for the positioning measurement reporting applied at the apparatus when the apparatus is unable to obtain any positioning measurement by carrier aggregation (CA) from a requested positioning frequency layer (PFL) of the plurality of positioning frequency layers (PFLs) indicated in the request by the location management function.

10. The apparatus according to claim 1, wherein the apparatus is further caused to:
transmit, in the positioning measurement report, at least one identifier for each positioning frequency layer (PFL) and PPW in which the measurement failed, or at least an indication of a failure event to obtain positioning measurement by carrier aggregation (CA).

11. An apparatus comprising:
at least one processor; and
at least one memory storing instructions that, when executed by the at least one processor, cause the apparatus at least to:
transmit, to a user equipment, configurations comprising rules to configure the user equipment to drop receiving positioning reference signals (PRS) resources when the user equipment fails to obtain a positioning measurement report by carrier aggregation (CA) within positioning processing windows (PPW) across a plurality of positioning frequency layers (PFLs); and
reconfigure and transmit, to the user equipment, one or more positioning processing windows (PPWs) for one or more of the plurality of positioning frequency layers (PFLs) that the user equipment previously failed to measure.

12. The apparatus according to claim 11, wherein the apparatus is further caused to transmit positioning reference resources over the plurality of positioning frequency layers (PFLs).

13. The apparatus according to claim 11, wherein the rules configure the user equipment such that when the user equipment drops receiving specific PRS resources within a PPW for one positioning frequency layer (PFL), the rules configure the user equipment to drop receiving PRS resources over all concurrent PPWs in all of the plurality of positioning frequency layers (PFLs).

14. The apparatus according to claim 11, wherein the rules configure the user equipment such that, when the user equipment cannot obtain the positioning measurement by the carrier aggregation (CA) from any two consecutive positioning frequency layers (PFLs), the rule configures the user equipment to drop receiving PRS resources in all PPWs in all of the plurality of positioning frequency layers (PFLs).

15. An apparatus comprising:
at least one processor; and
at least one memory storing instructions that, when executed by the at least one processor, cause the apparatus at least to:
provide, to a user equipment, a request and rules to report positioning measurement reporting by carrier aggregation (CA) across a plurality of positioning frequency layers (PFLs); and
receive, from the user equipment according to the provided rules, a positioning measurement report indicating at least one or more of the plurality of positioning frequency layers (PFLs) that the user equipment successfully measures or failed to measure.

16. The apparatus according to claim 15, wherein the provided rules configure the user equipment with the plurality of positioning frequency layers (PFLs) and one or more positioning reference signal processing windows (PPWs), wherein each PPW is associated with a respective positioning frequency layer (PFL).

17. The apparatus according to claim 15, wherein the positioning measurement report comprises one or more of:
a set of a positioning measurement, a PFL identifier (ID), and a transmission reception point (TRP) ID, that are successfully measured by the user equipment;
a set of the PFL ID and a PPW ID that the user equipment failed to measure;
the set of the PFL ID and the PPW ID that the user equipment successfully measured, when a quantity of successfully measured positioning frequency layers (PFLs) is less than a quantity of positioning frequency layers (PFLs) that the user equipment failed to measure;
the positioning measurement only when the reported positioning measurement is obtained by the carrier aggregation (CA) and not across all of the plurality of positioning frequency layers (PFLs); and
the positioning measurement, the PFL IDs, and the TRP ID, which are obtained by carrier aggregation (CA) from at least a portion of the plurality of positioning frequency layers (PFLs).

18. The apparatus according to claim 15, wherein the positioning measurement report comprises either no positioning measurement or at least an indication of a failure event of the user equipment to obtain positioning measurement by carrier aggregation (CA) from a requested positioning frequency layer (PFL) of the plurality of positioning frequency layers (PFLs).

19. The apparatus according to claim 15, wherein the apparatus is further caused to transmit, to a network entity, a request to reconfigure one or more PPWs, which are configured by a network node, for one or more of the plurality of positioning frequency layers (PFLs) in which the measurement failed.

20. The apparatus according to claim 15, wherein the apparatus is further caused to:
determine a location estimation of the user equipment based on the positioning measurement report.

21-40. (canceled)

41. A method comprising:
receiving, from a location management function, a request to report positioning measurement reporting by carrier aggregation across a plurality of positioning frequency layers (PFLs); and
transmitting, to the location management function according to provided rules, a positioning measurement report indicating at least one of the plurality of positioning frequency layers (PFLs) that an apparatus successfully measures or failed to measure.

42. The method according to claim 41, wherein the rules are provided by the location management function, to configure the apparatus with the plurality of positioning frequency layers (PFLs) and one or more positioning reference signal processing windows (PPW), wherein each PPW is associated with a respective positioning frequency layer (PFL).

43. The method according to claim 41, wherein the rules configure the apparatus to perform one or more of:
reporting that a set of a positioning measurement, a positioning frequency layer identifier (PFL ID), and a transmission reception point (TRP) ID, are successfully measured by the apparatus;
reporting a set of the PFL ID and a PPW ID that the apparatus has failed to measure;
reporting the set of the PFL ID and the PPW ID that the apparatus has successfully measured, when a quantity of successfully measured positioning frequency layers (PFLs) is less than a quantity of positioning frequency layers (PFLs) that the apparatus has failed to measure;
reporting the positioning measurement only when the reported positioning measurement is obtained by the carrier aggregation and not across all of the plurality of positioning frequency layers (PFLs); and
reporting the positioning measurement, the PFL IDs, and the TRP ID, which are obtained by carrier aggregation from at least a portion of the plurality of positioning frequency layers (PFLs).

44. The method according to claim 41, wherein positioning reference resources are transmitted from a transmission reception point (TRP) over the plurality of positioning frequency layers (PFLs).

45. The method according to claim 41, further comprising:
when the apparatus drops receiving specific PRS resources within a PPW for one positioning frequency layer (PFL), dropping receiving PRS resources over all concurrent PPWs in all of the plurality of positioning frequency layers (PFLs).

46. The method according to claim 41, further comprising:
when the apparatus cannot obtain the positioning measurement by the carrier aggregation from any two consecutive positioning frequency layers (PFLs), dropping receiving PRS resources in all PPWs in all of the plurality of positioning frequency layers (PFLs).

47. The method according to claim 41, wherein the positioning measurement report comprises one or more positioning measurements obtained from at least a part of the plurality of positioning frequency layers (PFLs).

48. The method according to claim 41, wherein the positioning measurement report comprises no positioning measurement.

49. The method according to claim 42, further comprising:
receiving information indicating one or more rules for the positioning measurement reporting applied at the apparatus when the apparatus is unable to obtain any positioning measurement by carrier aggregation (CA) from a requested positioning frequency layer (PFL) of the plurality of positioning frequency layers (PFLs) indicated in the request by the location management function.

50. The method according to claim 41, further comprising:
transmitting, in the positioning measurement report, at least one identifier for each positioning frequency layer (PFL) and PPW in which the measurement failed, or at least an indication of a failure event to obtain positioning measurement by carrier aggregation (CA).

51. A method comprising:
transmitting, to a user equipment, configurations comprising first rules to configure the user equipment to drop receiving positioning reference signals (PRS) resources when the user equipment fails to obtain a positioning measurement report by carrier aggregation (CA) within positioning processing windows (PPW) across a plurality of positioning frequency layers (PFLs); and
reconfiguring and transmitting, to the user equipment, one or more positioning processing windows (PPWs) for one or more of the plurality of positioning frequency layers (PFLs) that the user equipment previously failed to measure.

52. The method according to claim 51, further comprising:
transmitting positioning reference resources over the plurality of positioning frequency layers (PFLs).

53. The method according to claim 51, wherein the rules configure the user equipment such that when the user equipment drops receiving specific PRS resources within a PPW for one positioning frequency layer (PFL), the rules configure the user equipment to drop receiving PRS resources over all concurrent PPWs in all of the plurality of positioning frequency layers (PFLs).

54. The method according to claim 51, wherein the rules configure the user equipment such that, when the user equipment cannot obtain the positioning measurement by the carrier aggregation (CA) from any two consecutive positioning frequency layers (PFLs), the rule configures the user equipment to drop receiving PRS resources in all PPWs in all of the plurality of positioning frequency layers (PFLs).

55. A method comprising:
providing, to a user equipment, a request and rules to report positioning measurement reporting by carrier aggregation (CA) across a plurality of positioning frequency layers (PFLs); and
receiving, from the user equipment according to the provided rules, a positioning measurement report indicating at least one or more of the plurality of positioning frequency layers (PFLs) that the user equipment successfully measures or failed to measure.

56. The method according to claim 55, wherein the provided rules configure the user equipment with the plurality of positioning frequency layers (PFLs) and one or more positioning reference signal processing windows (PPWs), wherein each PPW is associated with a respective positioning frequency layer (PFL).

57. The method according to claim 55, wherein the positioning measurement report comprises one or more of:
a set of a positioning measurement, a PFL identifier (ID), and a transmission reception point (TRP) ID, that are successfully measured by the user equipment;
a set of the PFL ID and a PPW ID that the user equipment failed to measure;
the set of the PFL ID and the PPW ID that the user equipment successfully measured, when a quantity of successfully measured positioning frequency layers (PFLs) is less than a quantity of positioning frequency layers (PFLs) that the user equipment failed to measure;
the positioning measurement only when the reported positioning measurement is obtained by the carrier aggregation (CA) and not across all of the plurality of positioning frequency layers (PFLs); and
the positioning measurement, the PFL IDs, and the TRP ID, which are obtained by carrier aggregation (CA) from at least a portion of the plurality of positioning frequency layers (PFLs).

58. The method according to claim 55, wherein the positioning measurement report comprises either no positioning measurement or at least an indication of a failure event of the user equipment to obtain positioning measurement by carrier aggregation (CA) from a requested positioning frequency layer (PFL) of the plurality of positioning frequency layers (PFLs).

59. The method according to claim 55, further comprising:
transmitting, to a network entity, a request to reconfigure one or more PPWs, which are configured by a network node, for one or more of the plurality of positioning frequency layers (PFLs) in which the measurement failed.

60. The method according to claim 55, further comprising:
determining a location estimation of the user equipment based on the positioning measurement report.

61. A non-transitory computer readable storage medium storing instruction that, when executed by at least one processor of an apparatus, causes the apparatus at least to perform the method of claim 41.

62. A non-transitory computer readable storage medium storing instruction that, when executed by at least one processor of an apparatus, causes the apparatus at least to perform the method of claim 51.

63. A non-transitory computer readable storage medium storing instruction that, when executed by at least one processor of an apparatus, causes the apparatus at least to perform the method of claim 55.

64-66. (canceled)

67. An apparatus comprising one or more circuitry configured to perform the method of claim 41.

68. An apparatus comprising one or more circuitry configured to perform the method of claim 51.

69. An apparatus comprising one or more circuitry configured to perform the method of claim 55.
